(19) United States
(12) Patent Application Publication
(10) Pub. No.: US 2010/0319542 A1
(43) Pub. Date: Dec. 23, 2010

(54) SCRUBBING OF AMMONIA WITH UREA AMMONIUM NITRATE SOLUTION

(75) Inventors: Francis R. Alix, Rye, NH (US); Joanna Duncan, Springvale, ME (US)

Correspondence Address: Nikolas J. Uhlir;Powerspan Corp., 100 International Drive, SUITE 200, PORTSMOUTH, NH, 03801, US

(73) Assignee: POWERSPAN CORP., Portsmouth, NH (US)

(21) Appl. No.: 12/668,081

(22) PCT Filed: Jul. 11, 2008
(86) PCT No.: PCT/US08/69771

§ 371 Date: Jan. 7, 2010

Related U.S. Application Data
(60) Provisional application No. 60/949,298, filed on Jul. 12, 2007.

(51) Int. Cl. B01D 53/14

(52) U.S. Cl. 95/223; 95/206

(57) ABSTRACT

A process for scrubbing ammonia in a CO2 removal process having the steps of absorbing (204) at least some CO2 from a gas stream (202) with an ammonium carbonate solution or a mixed alkali solution, resulting in a release of >ammonia; regenerating (210) ammonium.carbonate or mixed alkali solution to produce a concentrated CO2 stream; capturing ammonia with an ammonia capture mass transfer apparatus (214). with a concentrated urea ammonium nitrate solution; adjusting the pH of the urea ammonium nitrate solution to between 4 and 6 with nitric acid; and adding urea to the urea ammonium nitrate solution, thereby producing a urea ammonium nitrate (UAN) fertilizer product ready for commercial distribution.

### BACKGROUND

1. Field of the Invention

The invention is in the field of absorbing ammonia in flue gas scrubbing.

2. Description of the Related Art

Scrubbing of carbon dioxide with ammonium carbonate solutions has been known for many years. One process for absorbing CO₂ uses either an ammonium carbonate solution or a mixed alkali solution, which can be ammonium and either potassium or sodium carbonate. However, due to the volatility of ammonia at the pHs required for carbon dioxide capture, it is necessary to capture any ammonia released from the solution if the process is to be used to remove CO₂ from flue gas. What is needed, therefore, is a method and apparatus for scrubbing ammonia vapor in a CO₂ scrubbing system.

### SUMMARY

The invention is a method and apparatus that satisfies the need for scrubbing ammonia vapor in a CO₂ scrubbing system. One method of absorbing the ammonia vapor is to use a urea solution that is pH adjusted with nitric acid to form a urea ammonium nitrate solution (UAN). Urea ammonium nitrate is composed of 30-35 wt % urea, 40-45 wt % ammonium nitrate, and 20-30% water and is a fertilizer that contains 28-32% nitrogen. The specific gravity of the solution ranges from 1.283 to 1.320 and has a pH of 7-7.5. When nitric acid and urea are combined in a ratio that produces a solution that is ammonia lean, the solution will have a pH of 4-6 and can be used with an appropriate mass transfer device to absorb ammonia. These and other features, aspects, and advantages of the present invention will become better understood with regard to the following description, claims, and accompanying drawings.

### DRAWINGS

FIG. 1 is a process flow diagram showing some of the components used to carry out the process of the present invention.

FIG. 2 is a process flow diagram describing the process of the present invention.

### DESCRIPTION

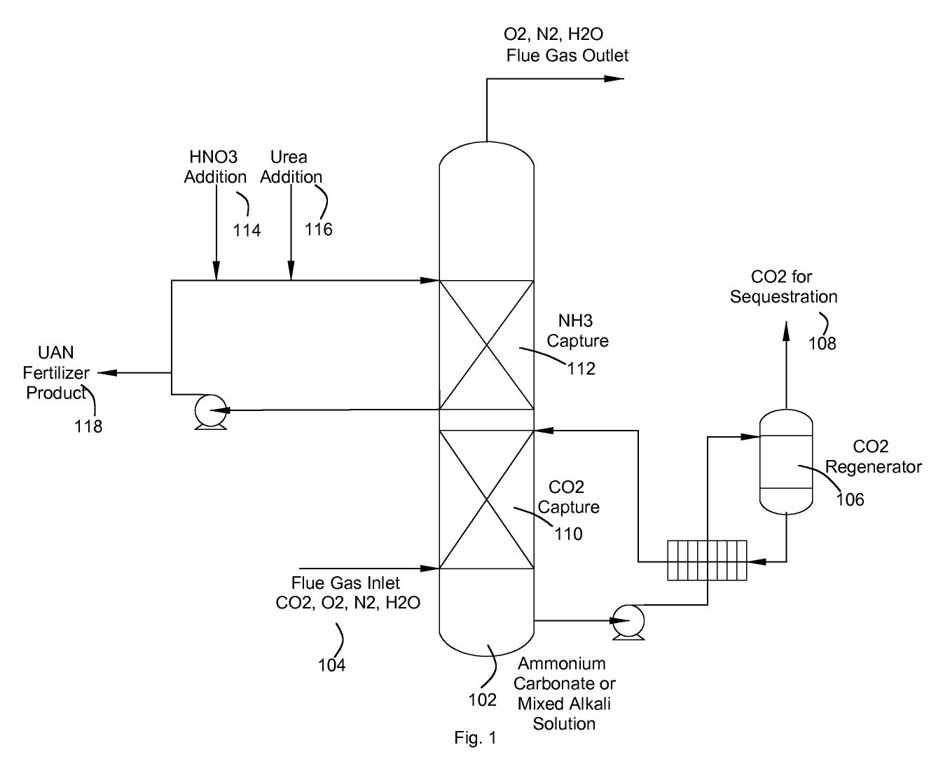

The invention is a method and apparatus that satisfies the need for scrubbing ammonia vapor in a CO₂ scrubbing system. As shown in FIG. 1, the ammonium carbonate or mixed alkali solution 102 is circulated to absorb CO₂ from a flue gas stream containing CO₂, H₂O, O₂, and N₂ 104. The solution is sent through a regenerator 106 to produce a concentrated CO₂ stream 108 ready for sequestration. Once regenerated the solution is recycled back to the CO₂ capture section 110 to absorb more CO₂. In the process of absorbing CO₂ ammonia is released. The amount of ammonia released is determined by the conditions of absorption and the composition of the absorbing solution but will be between 100-8000 ppm. After the CO₂ is captured, the flue gas moves to an ammonia capture mass transfer section 112 where a concentrated urea ammonium nitrate solution is circulating. The solution is pH adjusted to between 4 and 6 with nitric acid 114 to make the solution ammonia lean and forms ammonium nitrate as shown in equation (1).

HNO₃+NH₃→NH₄NO₃ (1)

Urea 116 is added to the solution either prior to the NH₃ capture 112 or after the formation of the ammonium nitrate to maintain a concentrated urea ammonium nitrate solution 118 ready for commercial distribution.

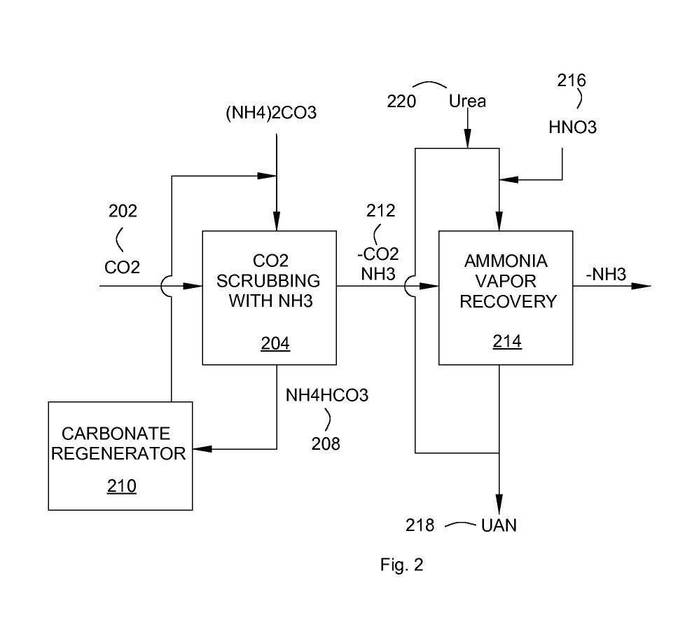

As shown in FIG. 2, a flue gas stream containing CO₂ 202 is brought into an absorption section 204 that uses an ammonium carbonate solution to absorb CO₂. The ammonium carbonate is converted into ammonium bicarbonate 208 through reaction of CO₂ with CO₃²⁻ as shown in (2):

CO₂+CO₃²⁻+H₂O→2HCO₄⁻ (2)

The ammonium bicarbonate solution is introduced into the regenerator 210, to reverse reaction (2) creating a concentrated CO₂ stream, which can be processed for sequestration or beneficial use. The regenerated solution is re-introduced into the absorber tower 204 to remove more CO₂.

Due to the volatility of the ammonium carbonate solution, the flue gas exits the absorber 204 with >70% CO₂ having been removed and with the addition of ammonia vapor. The CO₂ lean flue gas 212 now enters an ammonia vapor recovery 214 section to remove the ammonia vapor prior to leaving the stack. In the ammonia vapor recovery section, nitric acid 216 is added to a urea ammonium nitrate (UAN) solution to decrease the pH to <6. The UAN absorbs the ammonia vapor from the flue gas in a gas liquid contactor. When the UAN exits the contactor, part of the solution is removed as product 218 ready to be used as a fertilizer product while the rest is recycled back to the ammonia vapor recovery section 214. Additional urea 220 and HNO₃ acid 216 are added to maintain the required ratios of UAN and to maintain the ability to absorb NH₃ vapor.

The advantages of using UAN to do ammonia absorption as part of a CO₂ scrubbing process are:
1. The ability to produce a nitrogen fertilizer, which is the predominant plant nutrient required by crops.
2. The ability to produce a nitrogen fertilizer with minimal capital cost. Since the ammonia capture is required in the CO₂ scrubbing process, only incremental increases are required for the nitrogen fertilizer production including pumps and storage allowing one to take advantage of the infrastructure already in place.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A process for absorbing ammonia in a CO₂ removal process comprising the steps of:
absorbing at least some CO₂ from a gas stream with an ammonium carbonate solution or a mixed alkali solution, thereby releasing ammonia; and
absorbing ammonia using an ammonia absorption process, the ammonia absorption process comprising the steps of:
providing a urea ammonium nitrate solution;
adding an amount of nitric acid to the urea ammonium nitrate solution, thereby making the urea ammonium nitrate solution ammonia lean; and
contacting the ammonia with the ammonia lean urea ammonium nitrate solution to absorb ammonia and make an ammonia rich urea ammonium nitrate rich solution.

2. The process of claim 1, wherein the amount of nitric acid added is effective to change the pH to between about 4 and about 6.

3. The process of claim 1, further comprising the step of withdrawing urea ammonium nitrate.

4. The process of claim 3, further comprising the step of adding urea to the urea ammonium nitrate solution before contacting with ammonia.

5. The process of claim 3, further comprising the step of adding urea to the urea ammonium nitrate solution after contacting with ammonia.

6. A process for absorbing ammonia in a CO₂ removal process comprising the steps of:
absorbing at least some CO₂ from a gas stream with an ammonium carbonate solution or a mixed alkali solution, thereby releasing ammonia; and
absorbing ammonium using an ammonia absorption process, the ammonia absorption process comprising the steps of:
providing a urea ammonium nitrate solution;
adjusting the pH of the urea ammonium nitrate solution to between about 4 and about 6, thereby making the urea ammonium nitrate solution ammonia lean; and
contacting the ammonia with the ammonia lean urea ammonium nitrate solution to absorb ammonia and make an ammonia rich urea ammonium nitrate solution.

7. The process of claim 6, wherein adjusting the pH to between about 4 and about 6 is done by adding an effective amount of nitric acid.

8. The process of claim 6, further comprising the step of withdrawing urea ammonium nitrate.

9. The process of claim 8, further comprising the step of adding urea to the urea ammonium nitrate solution before contacting with ammonia.

10. The process of claim 8, further comprising the step of adding urea to the urea ammonium nitrate solution after contacting with ammonia.

11. A process of absorbing ammonia from a gas stream comprising the steps of:
providing a urea ammonium nitrate solution;
adding an amount of nitric acid to the urea ammonium nitrate solution, thereby making the urea ammonium nitrate solution ammonia lean; and
contacting the ammonia with the ammonia lean urea ammonium nitrate solution to absorb ammonia and make an ammonia rich urea ammonium nitrate solution.

12. The process of claim 11, wherein the amount of nitric acid is effective to change the pH to between about 4 and about 6.

13. the process of claim 11, further comprising the step of withdrawing urea ammonium nitrate.

14. The process of claim 13, further comprising the step of adding urea to the urea ammonium nitrate solution before contacting with ammonia.

15. The process of claim 13, further comprising the step of adding urea to the urea ammonium nitrate solution after contacting with ammonia.

16. A process for absorbing ammonia from a gas stream comprising the steps of:
providing a urea ammonium nitrate solution;
adjusting the pH of the urea ammonium nitrate solution to between about 4 and about 6, thereby making the urea ammonium nitrate solution ammonia lean; and
contacting the ammonia with the ammonia lean urea ammonium nitrate solution to absorb ammonia and make an ammonia rich urea ammonium nitrate solution.

17. The process of claim 16, wherein adjusting the pH to between about 4 and about 6 is done by adding an effective amount of nitric acid.

18. The process of claim 16, further comprising the step of withdrawing urea ammonium nitrate.

19. The process of claim 18, further comprising the step of adding urea to the urea ammonium nitrate solution before contacting with ammonia.

20. The process of claim 18, further comprising the step of adding urea to the urea ammonium nitrate solution after contacting with ammonia.
